(19) United States
(12) Patent Application Publication
(10) Pub. No.: US 2004/0143616 A1
(43) Pub. Date: Jul. 22, 2004

(54) Fast fourier transform processor

(75) Inventor: Kyung Won Kang, Seoul (KR)

Correspondence Address: Jonathan Y. Kang, LEE, HONG, DEGERMAN, KANG & SCHMADEKA, 14th Floor, 801 S. Figueroa Street, Los Angeles, CA, 90017, US

(73) Assignee: LG Electronics Inc.

(21) Appl. No.: 10/746,003

(22) Filed: Dec. 26, 2003

(30) Foreign Application Priority Data
Dec. 27, 2002 (KR) P2002-85083

(51) Int. Cl. G06F 15/00

(52) U.S. Cl. 708/404

(57) ABSTRACT

The present invention relates to a fast Fourier transform (FFT) processor using floating point calculation in the unit of pipeline stage. The FFT processor which includes an FFT processor performing fixed point calculation includes: a prescaler for detecting a maximum scale among input data and adjusting the data according to the maximum scale; and a postscaler for performing fixed point calculation according to the maximum scale and outputting a result of the fixed point calculation to a next stage. The pipeline configuration can be applied to even though the data is inputted in normal order, and also the storage area and operation complexity can be reduced.

This application claims the benefit of the Korean Application No. P2002-85083 filed on Dec., 27, 2002 which is hereby incorporated by reference.

### BACKGROUND OF THE INVENTION

1. Field of the Invention

The present invention relates to a fast Fourier transform processor, and more particularly, to a fast Fourier transform processor using floating point calculation in a unit of pipeline stage.

2. Discussion of the Related Art

Since digital communication is mainly used in most communication/broadcast area including digital broadcast, digital processes of each signal become essential. Accordingly, In order to digitally process a signal, it becomes more required to perform complex calculation on each signal in real time. Particularly, with advancing in integration technology of a signal processing circuit, fast Fourier transform (FFT) is used in various applications.

Meanwhile, since a signal process in a frequency domain is essential in a communication method such as Orthogonal Frequency Division Multiplexing (OFDM), a signal inputted in real time is required to process by FFT. When multi-path delay is caused too much due to a transmission channel in the digital TV broadcast environment to which the digital communication method is applied, a receiver should be designed to eliminate noises existing on the transmission channel so that audience can watch the broadcast program as clear as the original signal transmitted from the broadcast station.

In the transmission environment in which a plurality of signals are mixed and inputted through paths having long delay time, when a least mean square (LMS) filter is used so as to eliminate the noises mixed with the signals, complexity increases proportional to square of path length. Here, if a signal in a time domain is converted into a frequency domain, the complexity is greatly reduced.

An FFT processor that converts a time domain signal into a frequency domain signal and converts a frequency domain signal into a time domain signal inversely will be described.

FIG. 1 illustrates a frequency domain zero-forcing equalizer according to the related art.

As shown in FIG. 1, the equalizer includes a first FFT processor 101, a channel estimator 104, a second FFT processor 105, an inverse operator 106, a multiplier 102 and an inverse fast Fourier transform (IFFT) processor 103. The first FFT processor 101 receives a digital signal and converts the received digital signal into a first frequency domain signal. The channel estimator 104 receives the digital signal and estimates an impulse response (transmission environment) of a channel through which the digital signal is transmitted. The second FFT processor 105 converts the estimated impulse response into a second frequency domain signal. The inverse operator 106 obtains a reciprocal of the second frequency domain signal. The multiplier 102 multiplies the reciprocal and the first frequency domain signal. The IFFT processor 103 performs IFFT on the output of multiplier 102.

The equalizer receives the digital signal and outputs a time domain signal equalized suitable for transmission channel environment. This is an example in which a time domain signal is equalized in a frequency domain.

FIG. 2 illustrates an FFT processor using a general Cooley-Turkey algorithm.

As shown in FIG. 2, the FFT processor includes an input buffer 201, a butterfly operator 202, a coefficient ROM 203, a memory 204 and a controller 205. The input buffer 201 stores inputted data temporarily. The butterfly operator 202 performs a butterfly operation. The coefficient ROM 203 stores twiddle coefficients. The memory 204 stores intermediate data. The controller 205 synchronizes each of the elements.

The operation of the FFT processor will be described.

Input data is sequentially stored in the input buffer 201 to process the input data. Then, the butterfly operator 202 reads the input data and the twiddle coefficient from the input buffer 201 and the coefficient ROM 203 respectively, performs butterfly operation, and then stores the result of the butterfly operation in the memory 204.

When the looped operation described above is performed, the butterfly operator 202 receives the next data and a resulting value from the input buffer 201 and the memory 204 respectively, performs the butterfly operation, and then stores the result of the butterfly operation in the memory 204 again. After repeating such a process, the final result is temporarily stored in the memory 204, and then is outputted to the outside along with a synchronization signal of the controller 205 in synchronization with the synchronization signal.

Such an algorithm is capable of FFT operation but requires a synchronization signal having higher frequency so as to process data inputted in real time.

To overcome the above-mentioned problem, an FFT processor is configured in pipeline form as shown in FIG. 3. In other words, stages for algorithm operation are connected to each other in the pipeline form, and each of the stages has a memory to continuously process input data.

In more detail, a first stage 301_1 receives the input data and the synchronization signal and then outputs the result of process to a next stage 301_2. The second stage 301_2 receives the output of the first stage 301_1 and the synchronization signal, and then outputs the result of process to a next stage. In this way, the final stage 301_N outputs a final FFT result.

The FFT processor described above has the operation time from operation start to final output, which is as the same as the FFT processor shown in FIG. 2. As the number of the simultaneously processing operators is increased, the processing time is actually decreased so that the FFT processor shown in FIG. 3 is very suitable to process the continuously inputted data.

FIG. 4 illustrates a single path delay commutator type FFT processor according to the related art.

As shown in FIG. 4, the FFT processor includes a delay commutator 401, a butterfly operator 402, a coefficient ROM 404, a multiplier 403 and a controller 405. The delay commutator 401 stores input data temporarily and outputs the data according to the number of the data required by the butterfly operator 402. The butterfly operator 402 performs a butterfly operation. The coefficient ROM 404 stores twiddle coefficients. The multiplier 403 multiplies the output of the butterfly operator 402 and the output of the coefficient ROM 404. The controller 405 synchronizes each of the elements.

The delay commutator 401 consists of a first-in-first-out (FIFO) memory (not shown) and a commutator (not shown), and determines the number of the input data required by the butterfly operator 402 according to the size of Radix_N to output the data. Then, the butterfly operator 402 receives the data and performs butterfly operation on the data. The multiplier 403 multiplies the operated data with a proper twiddle coefficient, and outputs the multiplication result to the next stage. Here, since the stages are designed to have different time delays between data input and data output, which are necessary for operation according an FFT algorithm, the controller 405 synchronizes the stages and selectively extracts the outputs of the stages.

If stages configured in the above-mentioned way are arranged in pipeline form, the total number of memories required for FFT operation is 2(N−1) so that memory configuration is very efficient. Since the stages are repeated and each stage has substantially the same configuration, it is very advantageous to configure a system.

On the other hand, when configuring an FFT processor, the length of a stage should be actually considered.

Considering the fixed length of the stage according to hardware area, as the FFT has the larger block size, the number of the operation stage increases so that the error increases gradually. If all the operations consist of floating point calculations, the error is minimized but the complexity of hardware is greatly increased.

Accordingly, if the scale of FFT operation is adjusted block by block, the loss can be minimized only with floating point calculation. In this case, since all the results of each block should be known to adjust the scale of the FFT operation, it is not proper to the pipeline configuration.

FIG. 5 illustrates convergence characteristic of the FFT operation according to the related art.

Referring to FIG. 5 illustrating convergence characteristics of an FFT operation, the locations of input values required by operation of a stage, which are within a block, converges into a predetermined block of the next stage. In this case, the bit order of data is changed from normal order to bit-reverse order so that the data is sorted as it travels the stages. If the data of the bit-reverse order is inputted, the output data has the normal order to the contrast. In this case, the operation flow does not have the convergence characteristic but the data location diverges gradually.

Accordingly, the structure of the FFT processor should be designed considering such floating point calculations.

FIG. 6 illustrates an FFT processor based on convergence block floating point calculation according to the related art.

As shown in FIG. 6, the FFT processor is constituted by adding an operation block 610 to the structure of FIG. 4.

The operation block 610 includes a data buffer 611, a scaler 612, a scale detector 613 and a scale buffer 614. The data buffer 611 collects data as much as delay time required for operation of the next stage to adjust scale. The scale buffer 614 delays a scale input of the previous stage as much as the delay time. The scale detector 613 finds the maximum scale in a predetermined block. The scaler 612 sorts scales of data according to the maximum scale.

Here, the adder 615 adds the current scale and the scale of the previous stage, and then outputs the sum of the scales to the next stage.

In the configuration described above, the fixed point calculation is performed in the configuration of FIG. 4 and the operation block performs floating point calculation.

However, an FFT processor based on the convergence block floating point calculation has the following problems.

First, when the data for FFT operation are inputted in normal order and the bits representing order are outputted in bit-reverse order, the data has a convergence characteristic. The FFT processor uses the convergence characteristic. So, the configuration described above cannot be used when the input order is bit-reverse order and the output order is normal order.

Since the operation is block unit floating point calculation, a buffer of block size is required so that the number of the buffers is increased proportional to FFT block size. Therefore, a basic single path delay commutator further requires a considerable memory.

### SUMMARY OF THE INVENTION

Accordingly, the present invention is directed to a fast Fourier transform processor that substantially obviates one or more problems due to limitations and disadvantages of the related art.

An object of the present invention is to provide a fast Fourier transform processor having configuration for efficient floating point calculation in which data scale operation is performed in the unit of pipeline stage.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided a fast Fourier transform (FFT) processor according to the present invention, which includes an FFT processor performing fixed point calculation, including: a prescaler for detecting a maximum scale among input data and adjusting the data according to the maximum scale; and a postscaler for performing fixed point calculation according to the maximum scale and outputting a result of the fixed point calculation to a next stage.

Here, the prescaler includes: a maximum scaler detector for receiving data including a scale, and detecting data including the maximum scale; and a scaler for adjusting all the inputted data according to the detected maximum scale.

Also, the postscaler includes: a most significant bit (MSB) detector for detecting MSB from fixed point data; a scaler for changing a scale so that valid data of the fixed point data is maximum; an offset value output unit for adjusting a scale in each stage; and an adder for adding the detected MSB and the offset value and outputting an addition result to a next stage.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 illustrates a frequency domain zero-forcing equalizer according to the related art;

FIG. 2 illustrates an FFT processor using a general Cooley-Turkey algorithm;

FIG. 3 illustrates a pipeline type FFT processor according to the related art;

FIG. 4 illustrates a single path delay commutator type FFT processor according to the related art;

FIG. 5 illustrates convergence characteristic of the FFT calculation according to the related art;

FIG. 6 illustrates an FFT processor based on convergence block floating point calculation according to the related art;

FIG. 7 illustrates an FFT processor according to the present invention;

FIG. 8 illustrates a prescaler of FIG. 7; and

FIG. 9 illustrates a postscaler of FIG. 7.

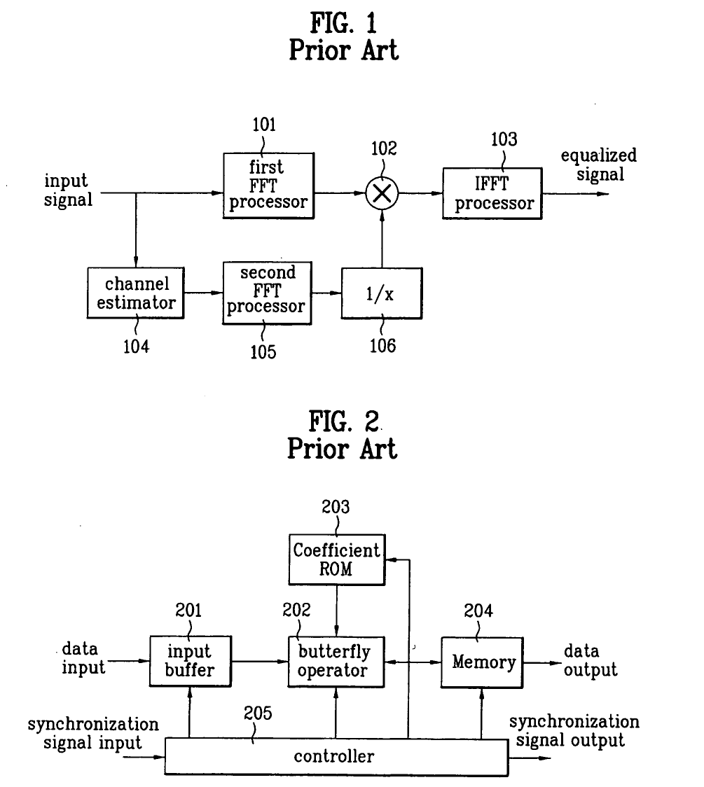

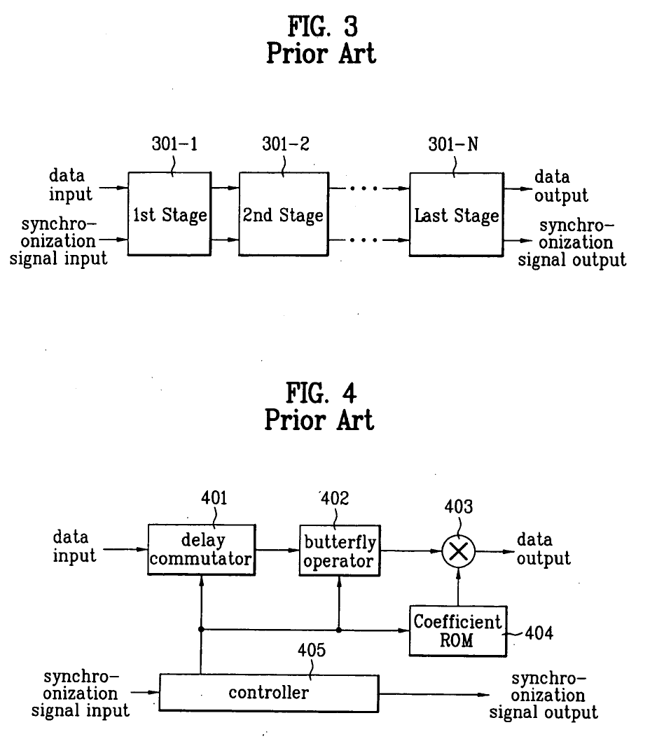

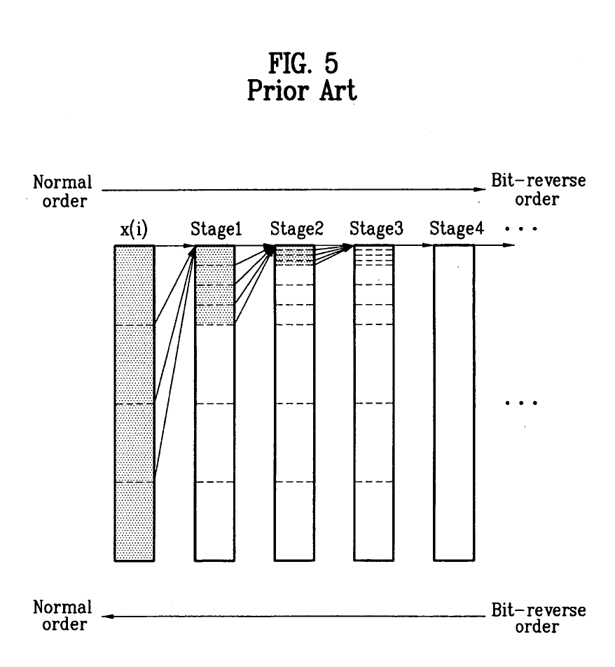

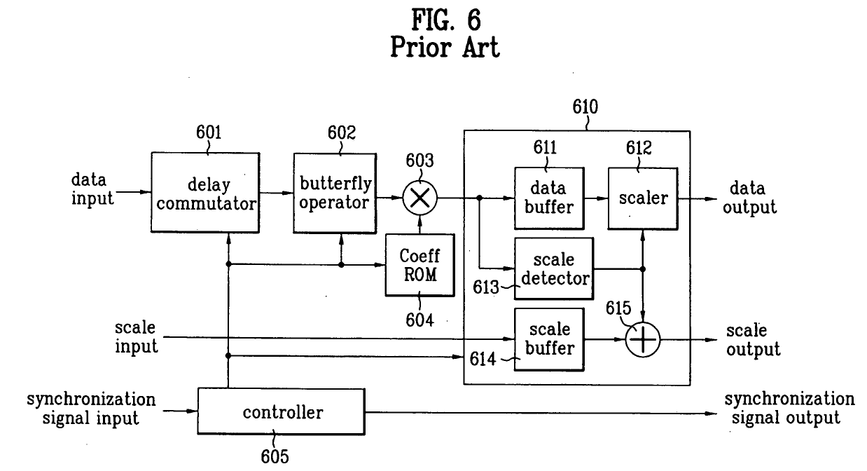

### DETAILED DESCRIPTION OF THE INVENTION

Reference will now be made in detail to the preferred embodiments of the present invention, examples of which are illustrated in the accompanying drawings.

To solve the problems of the related art, in the present invention data scale is not processed block by block but floating point calculation is performed in the unit of pipeline, so that the FFT processor can have more efficient configuration.

The preferred embodiments of the present invention, which concretely achieve objects of the present invention.

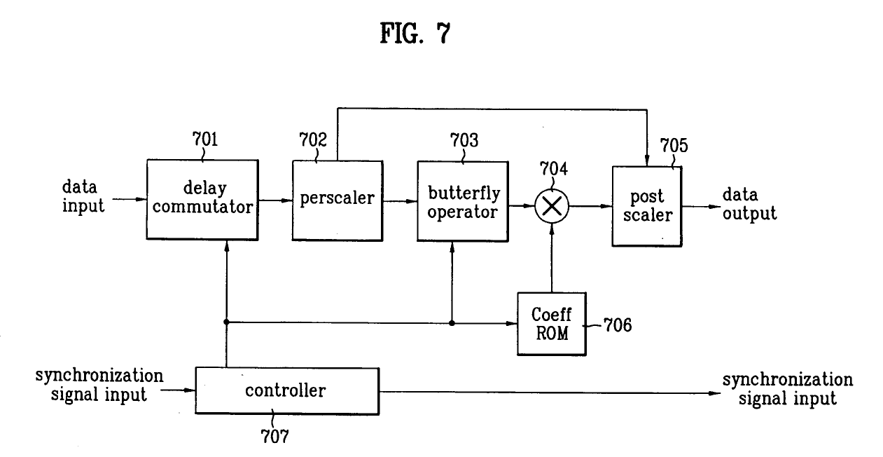

FIG. 7 illustrates an FFT processor according to the present invention.

As shown in FIG. 7, the FFT processor includes a delay commutator 701, a prescaler 702, a controller 707, a butterfly operator 703, a coefficient ROM 706, a multiplier 704 and a postscaler 705. The delay commutator 701 receives and stores data and a scale, and selects and extracts one of the data and the scale when necessary. The prescaler 702 compares the scales of the data and adjusts the data according to a maximum scale. The controller 707 receives a synchronization signal from an outside, synchronizes each element of the FFT processor, and controls selection and extraction of the delay commutator 701. The butterfly operator 703 performs butterfly operation. The coefficient ROM 706 stores a twiddle coefficient. The multiplier 704 multiplies an output of the butterfly operator 703 and an output of the coefficient ROM 706. The postscaler 705 performs fixed point calculation for all the basic FFT operation, converts the result of the fixed point calculation into the floating point form according to the maximum scale, and outputs the converted result to the next stage.

The operation of the FFT processor described above will be described above.

First, the FFT processor receives data, a scale and a synchronization signal used to synchronize the internal elements of the FFT processor.

The delay commutator 701 receives data and a predetermined scale, and stores them in its own memory (not shown) with outputting them to the prescaler 702. Then, the prescaler 702 receives the data and the scales corresponding to the data, adjusts scales of the remaining data according to a maximum scale, and outputs the data and their adjusted scales to the butterfly operator 703. The determined maximum scale is inputted to the postscaler 705. The data having the adjusted scale is processed in the way of the fixed point calculation while the data experiences the butterfly operator 703, the coefficient ROM 706 and the multiplier 704. Then, the processed data is inputted to the postscaler 705. Here, the controller 707 synchronizes the delay commutator 701, the butterfly operator 703 and the coefficient ROM 706.

The postscaler 705 receives the maximum scale and the FFT data processed in the way of the fixed point calculation from the prescaler 702 and the multiplier 704 respectively, converts the FFT data into the floating point form, and outputs the converted FFT data to the next stage.

Here, the prescaler 702 and the postscaler 705 will be described in detail.

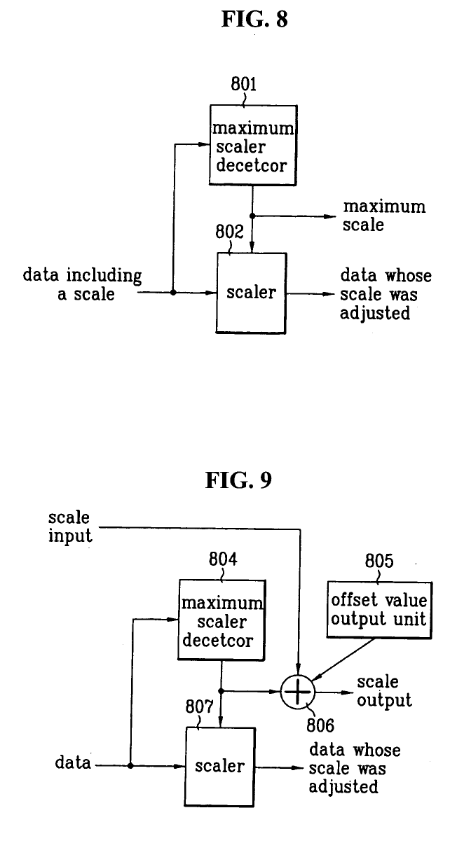

FIG. 8 illustrates a prescaler of FIG. 7.

As shown in FIG. 8, the prescaler includes a maximum scaler detector 801 and a scaler 802. The maximum scaler detector 801 receives data including a scale and detects data including the maximum scale. The scaler 802 adjusts all the inputted data according to the detected maximum scale.

Here, the data adjusted by the scaler 802 is fixed point data.

FIG. 9 illustrates a postscaler of FIG. 7.

As shown in FIG. 8, the postscaler includes a most significant bit (MSB) detector 804, a scaler 807, an offset value output unit 805 and an adder 806. The most significant bit (MSB) detector 804 detects MSB from the fixed point data. The scaler 807 changes a scale so that valid data of the fixed point data is the maximum. The offset value output unit 805 adjusts a scale in each stage. The adder 806 adds the detected MSB and the outputted offset with reference to the scale of the calculated current input data.

Here, when each stage outputs scale to a next stage, more scales are added as stages are repeated. Offset value is adjusted to minimize the increasing bit length so that the numbers of data bits used to scale the data in all the stages are actually the same.

The offset value output unit 805 is designed to minimize the chip area for scale storage and scale operation. Then, the offset value output unit 805 links the output data and its scale and outputs the linked output data to the next stage in the floating point form.

As described above, since the FFT processor performs fixed point calculation in each stage of the pipeline, the additional buffer required for convergence block floating point calculation is not necessary so that the chip area of the FFT processor.

In addition, the pipeline configuration can be applied even in the case FFT input data has bit-reverse order and output data has normal order.

In floating point representation, the offset value of each stage is adjusted to minimize the bit length for scale and to reduce the corresponding storage area and calculation complexity.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A fast Fourier transform (FFT) processor comprising an FFT processor performing fixed point calculation, comprising:
a prescaler for detecting a maximum scale among input data and adjusting the data according to the maximum scale; and
a postscaler for performing fixed point calculation according to the maximum scale and outputting a result of the fixed point calculation to a next stage.

2. The FFT processor of claim 1, wherein the prescaler comprising:
a maximum scaler detector for receiving data comprising a scale, and detecting data comprising the maximum scale; and
a scaler for adjusting all the inputted data according to the detected maximum scale.

3. The FFT processor of claim 1, wherein the postscaler comprising:
a most significant bit (MSB) detector for detecting MSB from fixed point data; and
a scaler for changing a scale so that valid data of the fixed point data is maximal;
an offset value output unit for adjusting a scale in each stage; and
an adder for adding the detected MSB and the offset value and outputting an addition result to a next stage.

4. The FFT processor of claim 3, wherein the offset value output unit minimizes bit length for scaling in each stage.

5. A FFT processor comprising:
a delay commutator for receiving and storing data and a scale, and selecting and extracting one of the data and the scale when necessary;
a prescaler for comparing the scales of the data and adjusting the data according to a maximum scale;
a controller for receiving a synchronization signal from an outside, synchronizing each element of the FFT processor, and controlling selection and extraction of the delay commutator;
a butterfly operator for performing butterfly operation;
a coefficient ROM for storing a twiddle coefficient;
a multiplier for multiplying an output of the butterfly operator and an output of the coefficient ROM; and
a postscaler for performing fixed point calculation according to the maximum scale.

6. The FFT processor of claim 5, wherein the prescaler comprising:
a maximum scaler detector for receiving data comprising a scale, and detecting data comprising the maximum scale; and
a scaler for adjusting all the inputted data according to the detected maximum scale.

7. The FFT processor of claim 5, wherein the postscaler comprising:
a most significant bit (MSB) detector for detecting MSB from fixed point data;
a scaler for changing a scale so that valid data of the fixed point data is maximal;
an offset value output unit for adjusting a scale in each stage; and
an adder for adding the detected MSB and the outputted offset.
